(19) United States
(12) Patent Application Publication
(10) Pub. No.: US 2012/0092271 A1
(43) Pub. Date: Apr. 19, 2012

(54) COMPUTER INPUT DEVICE WITH EL PANEL AND TOUCH PAD

(75) Inventors: Yung-Lung Liu, Ta Ya Shiang (TW); Cheng-Tsung Juan, Ta Ya Shiang (TW)

(73) Assignee: Sunrex Technology Corp., Ta Ya Shiang (TW)

(21) Appl. No.: 12/906,972

(22) Filed: Oct. 18, 2010

(51) Int. Cl. G06F 3/041

(52) U.S. Cl. 345/173

(57) ABSTRACT

A computer input device includes a touch pad module comprising a flexible, rectangular, optically transmissive touch pad and a touch pad controller electrically interconnecting the touch pad and a microprocessor; a flexible, rectangular characters printing membrane disposed under the touch pad; and an EL module comprising at least one flexible, rectangular EL panel disposed under the characters printing membrane, and a programmable driver electrically interconnected the microprocessor and the at least one EL panel, the programmable driver being adapted to program to sequentially activate the at least one EL panel for controlling brightness, color, and overlap of a plurality of light emitting areas of the computer input device.

### BACKGROUND OF THE INVENTION

1. Field of Invention

The invention relates to computer input devices and more particularly to a computer input device having an EL panel and a touch pad with improved characteristics.

2. Description of Related Art

Laptops are widely used by people through out the world due to lightweight and compactness. Typically, a laptop is equipped with a membrane keyboard having a scissors type structure. The scissors type structure is mounted between upper keycaps and a lower rubber plate.

There is a thin profile light permeable keyboard including keys, scissors type structures, a rubber plate, a luminescence board, a film circuit board, and a base board. Each key has a top face coated with a light permeable substrate layer, a light impermeable coating layer, and a light permeable protection layer. Each scissors type structure is pivoted between each key and the rubber plate. The luminescence board is mounted between the rubber plate and the film circuit board so as to emit light of single color for illuminating the printed characters, symbols, and numbers on key tops. This enables a user to operate the computer in a dark environment.

However, the conventional thin profile light permeable keyboard suffers from a couple of disadvantages. For example, its construction and mechanism are complicated. Further, the number of its components is excessive.

Touch panels, touch pads, and touchscreens are developed as technology advances. They are widely employed in mobile phones, laptops, etc. For example, a touch pad comprises a top ITO (indium tin oxide) glass and a lower ITO film. For a resistive touch pad, a plurality of spacers are provided between the ITO glass and the ITO film so that a short circuit between the ITO glass and the ITO film can be prevented.

EL (electroluminescence) technology has been widely employed in lighting applications and billboards for advertisement. EL is an optical phenomenon and electrical phenomenon in which a material emits light in response to an electric current passed through it, or to a strong electric field. EL devices are advantageous for low power consumption, lightweight, long life, high brightness, subtle light rays, etc. One typical application is powder phosphor-based electroluminescent panels used as backlights to liquid crystal displays.

Thus, the need for combining touch pad and EL technology into a computer input device exists.

### SUMMARY OF THE INVENTION

It is therefore one object of the invention to provide a computer input device having an EL panel and a touch pad in which a programmable driver can be programmed to sequentially activate at least one EL panel for controlling brightness, color, and overlap of a plurality of light emitting areas of each EL panel so that a colorful backlight can be rendered to the computer input device. Moreover, in cooperation with a plurality of virtual keys each printed with a character, number, or function number it is possible of illuminating the keys for ease of key operation.

To achieve the above and other objects, the invention provides a computer input device comprising a touch pad module comprising a flexible, rectangular, optically transmissive touch pad and a touch pad controller electrically interconnecting the touch pad and a microprocessor; a flexible, rectangular characters printing membrane disposed under the touch pad; and an EL module comprising at least one flexible, rectangular EL panel disposed under the characters printing membrane, and a programmable driver electrically interconnected the microprocessor and the at least one EL panel, the programmable driver being adapted to program to sequentially activate the at least one EL panel for controlling brightness, color, and overlap of a plurality of light emitting areas of the computer input device.

The above and other objects, features and advantages of the invention will become apparent from the following detailed description taken with the accompanying drawings.

### BRIEF DESCRIPTION OF THE DRAWINGS

FIG. 1 is block diagram of a computer input device incorporating a touch pad and an EL panel according to the invention;

FIG. 2 is an exploded view of the computer input device according to a first preferred embodiment of the invention;

FIG. 3 is a longitudinal sectional view of the EL panel of FIG. 2;

FIG. 4 is an exploded view of the computer input device according to a second preferred embodiment of the invention; and

FIG. 5 is an exploded view of the computer input device according to a third preferred embodiment of the invention.

### DETAILED DESCRIPTION OF THE INVENTION

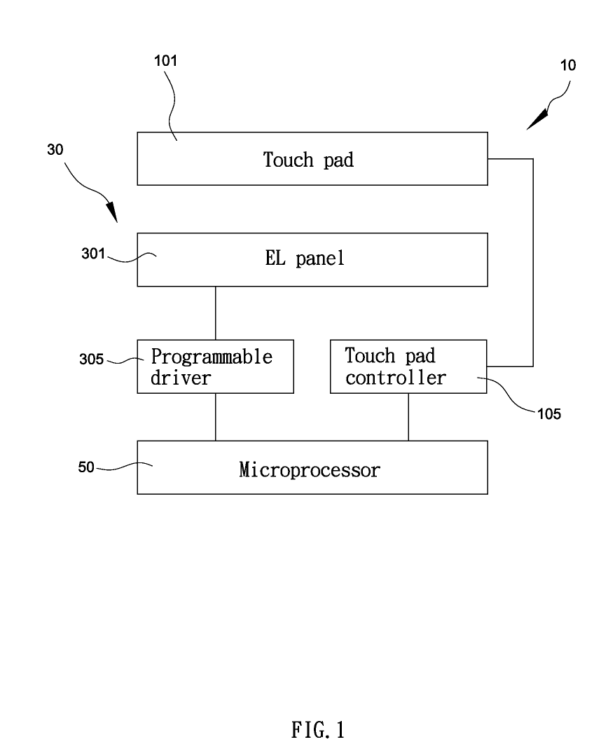

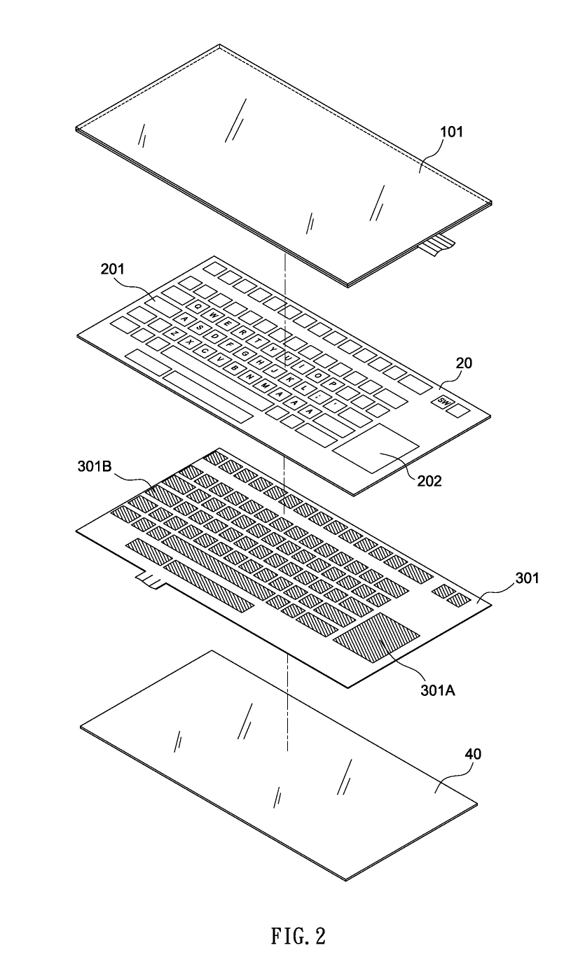

Referring to FIGS. 1 to 3, a computer input device in accordance with a first preferred embodiment of the invention comprises the following components as discussed in detail below.

A touch pad module 10 comprises a flexible, rectangular, optically transmissive touch pad 101 and a touch pad controller 105. The touch pad 101 comprises a top ITO glass and a bottom ITO film separated by a plurality of spacers therebetween. Touch pad is a well known device so that a detailed description thereof is omitted herein for the sake of brevity. The touch pad controller 105 is electrically interconnected the touch pad 101 and a microprocessor 50 which is in turn electrically connected to a motherboard of a computer. The touch pad controller 105 is capable of converting an analog signal generated by pressing the touch pad 101 by a user into a digital signal, calculating position of the finger touch in the form of coordinate position, converting the coordinate position into a touch signal, and sending the touch signal containing the coordinate position to the microprocessor 50 via a USB (universal serial bus), thereby effecting a touch pad input. A loud speaker or a vibrator (both not shown) can be activated when the touch signal is created so as to either audibly or physically alert the user about the successful touch.

A flexible, rectangular characters printing membrane 20 is provided under the touch pad 101. A top surface of the characters printing membrane 20 is provided with a plurality of virtual keys 201 each printed with a character, number, or function number, and a touch area 202 to the right. By configuring as above, a user may press a virtual key 201 to input, for example, a letter or a computer command. Alternatively, the user may use his or her finger to move on the touch area 202 to operate the touch area 202 as a computer mouse.

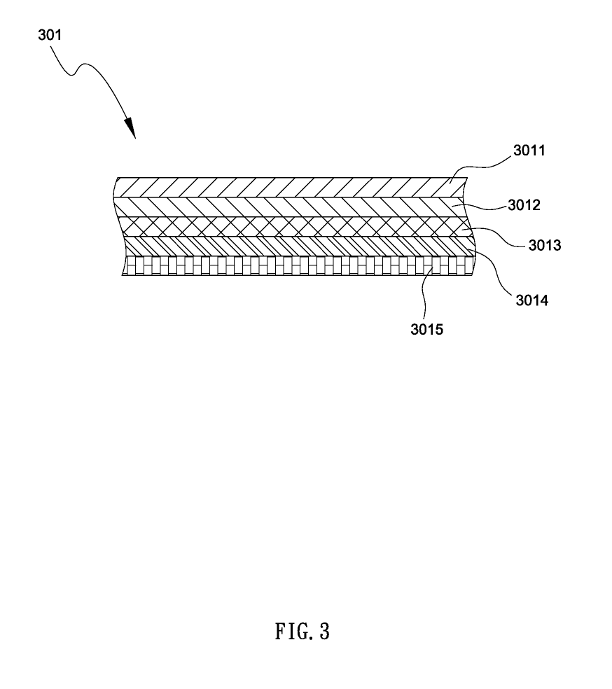

An EL module 30 comprises a flexible, rectangular EL panel 301 and a programmable driver 305. The EL panel 301 is provided under the characters printing membrane 20 and functions as an EL type backlight to the computer input device. The EL panel 301 is a multi-layered structure as shown in FIG. 3. In detail, the EL panel 301 comprises, from top to bottom, a transparent protective layer 3011, a transparent conduction layer 3012, a light emitting layer 3013, a dielectric layer 3014, and an electrode layer 3015. The transparent conduction layer 3012 is an ITO film for directing light emitted by the light emitting layer 3013 toward the transparent protective layer 3011. The light emitting layer 3013 is made of ZnS (zinc sulfide). ZnS molecules of the light emitting layer 3013 may be activated to emit light when electric field is generated by applying AC (alternating current) to both the transparent conduction layer 3012 and the electrode layer 3015 (i.e., electric power is converted into light).

The programmable driver 305 is electrically interconnected the microprocessor 50 and the EL panel 301 for adjusting brightness or flashing of the EL panel 301. Top surface of the EL panel 301 is divided into a plurality of light emitting areas 301A, 301B, etc. A user may operate a switch to switch among the light emitting areas so as to illuminate or flash a specific one of the light emitting areas, i.e., virtual key 201 on the characters printing membrane 20. Either the arrangement of the light emitting layer 3013 and the electrode layer 3015 or by adjusting voltage and frequency of the electrodes can control the light emitting areas and brightness of the EL panel 301. In general, high voltage and low current are required for the EL panel 301. Also, brightness of the EL panel 301 increases as voltage and frequency increase.

A flexible, rectangular base plate 40 is provided under the EL panel 301 as support and reflector.

The microprocessor 50 is electrically connected to both the touch pad controller 105 and the programmable driver 305. Also, the microprocessor 50 is electrically connected to a motherboard of a computer so as to send a touch signal thereto for further processing.

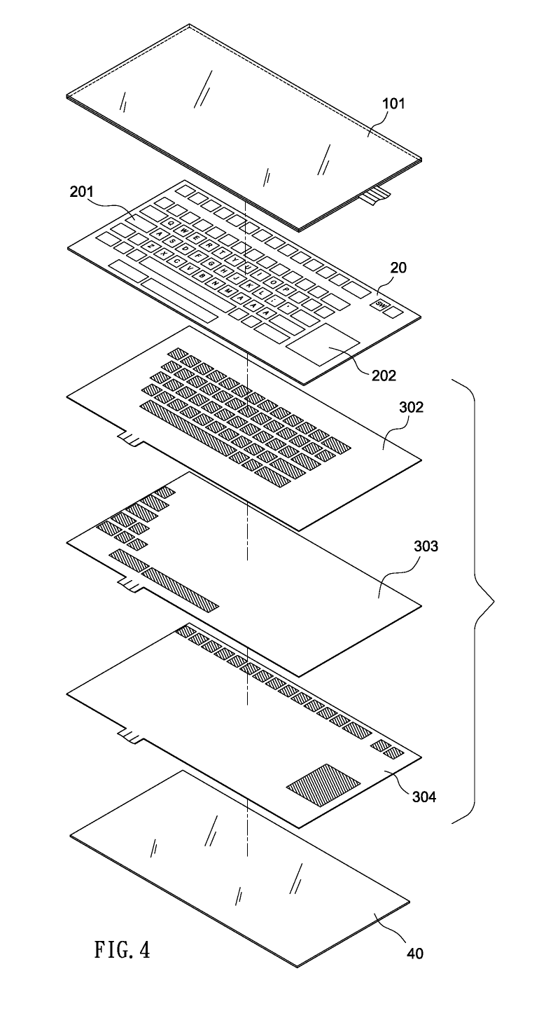

Referring to FIG. 4, a computer input device in accordance with a second preferred embodiment of the invention is shown. The characteristics of the second preferred embodiment of the invention are discussed in detail below. The EL module is replaced by a top EL panel 302, an intermediate EL panel 303, and a bottom EL panel 304. The EL panels 302, 303, and 304 are electrically connected to the programmable driver 305. Thus, the programmable driver 305 can be programmed to sequentially activate the EL panels 302, 303 and 304 for controlling illumination. In detail, the programmable driver 305 is capable of controlling brightness, color, and overlap of the light emitting areas of the EL panels 302, 303 and 304 so that a colorful backlight can be rendered to the computer input device. Moreover, in cooperation with the virtual keys 201 each printed with a character, number, or function number, it is possible of illuminating the virtual keys 201. In brief, the second preferred embodiment of the invention can sufficiently illuminate keys for user operation of the computer input device.

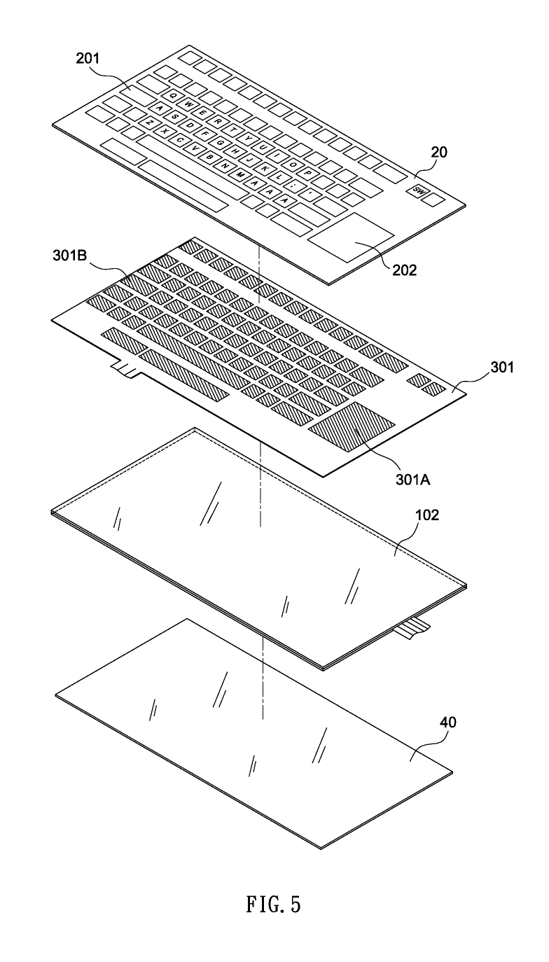

Referring to FIG. 5, a computer input device in accordance with a third preferred embodiment of the invention is shown. The characteristics of the third preferred embodiment of the invention are discussed in detail below. The characters printing membrane 20 is provided on top, the EL panel 301 is provided in the middle, and an opaque touch pad 102 is provided below the EL panel 301. Both the EL panel 301 and the characters printing membrane 20 are flexible. Thus, a user may use the finger to press the characters printing membrane 20 and thus the EL panel 301 to depress the opaque touch pad 102 for key pressing purposes. The opaque touch pad 102 is cost effective so as to greatly reduce the manufacturing cost of the computer input device and thus be competitive in the market.

Advantages and characteristics of the invention are described below. The computer input device comprises a flexible, optically transmissive touch pad 101 on top and at least one EL panel therebelow. Each EL panel is electrically connected to a programmable driver 305. Thus, the programmable driver 305 can be programmed to sequentially activate the EL panels for controlling brightness, color, and overlap of the light emitting areas of the EL panels so that a colorful backlight can be rendered to the computer input device. Moreover, in cooperation with the virtual keys 201 each printed with a character, number, or function number it is possible of illuminating the keys for ease of key operation.

While the invention has been described in terms of preferred embodiments, those skilled in the art will recognize that the invention can be practiced with modifications within the spirit and scope of the appended claims.

What is claimed is:

1. A computer input device comprising:
a touch pad module comprising a flexible, rectangular, optically transmissive touch pad and a touch pad controller electrically interconnecting the touch pad and a microprocessor;
a flexible, rectangular characters printing membrane disposed under the touch pad; and
an EL (electroluminescence) module comprising at least one flexible, rectangular EL panel disposed under the characters printing membrane, and a programmable driver electrically interconnected the microprocessor and the at least one EL panel, the programmable driver being adapted to program to sequentially activate the at least one EL panel for controlling brightness, color, and overlap of a plurality of light emitting areas of the computer input device.

2. The computer input device of claim 1, wherein the touch pad comprises a top ITO (indium tin oxide) glass and a bottom ITO film.

3. The computer input device of claim 1, wherein the touch pad controller is adapted to convert an analog signal generated by pressing the touch pad into a digital signal, calculate position of the pressing in a form of coordinate position, convert the coordinate position into a touch signal, and send the touch signal containing the coordinate position to the microprocessor via a USB (universal serial bus), further comprising a loud speaker or a vibrator which can be activated when the touch signal is created so as to either audibly or physically alert about the successful pressing.

4. The computer input device of claim 1, wherein a top surface of the characters printing membrane is provided with a touch area and a plurality of virtual keys each printed with a character, number, or function number.

5. The computer input device of claim 1, wherein the EL panel comprises, from top to bottom, a transparent protective layer, a transparent conduction layer, a light emitting layer, a dielectric layer, and an electrode layer, wherein the transparent conduction layer is an ITO film, and wherein the light emitting layer is formed of ZnS (zinc sulfide).

6. The computer input device of claim 1, wherein a top surface of each EL panel is divided into a plurality of light emitting areas.

7. The computer input device of claim 1, further comprising a flexible, rectangular base plate under the at least one EL panel as computer input device support and reflector.

8. A computer input device comprising:
a flexible, rectangular characters printing membrane on top;
a touch pad module disposed under the characters printing membrane and comprising a flexible, rectangular, opaque touch pad and a touch pad controller electrically interconnecting the touch pad and a microprocessor; and
an EL module comprising at least one flexible, rectangular EL panel disposed between the characters printing membrane and the touch pad, and a programmable driver electrically interconnected the microprocessor and the at least one EL panel, the programmable driver being adapted to program to sequentially activate the at least one EL panel for controlling brightness, color, and overlap of a plurality of light emitting areas of the computer input device.

9. The computer input device of claim 8, wherein the touch pad controller is adapted to convert an analog signal generated by pressing the touch pad into a digital signal, calculate position of the pressing in a form of coordinate position, convert the coordinate position into a touch signal, and send the touch signal containing the coordinate position to the microprocessor via a USB (universal serial bus), further comprising a loud speaker or a vibrator which can be activated when the touch signal is created so as to either audibly or physically alert about the successful pressing.

10. The computer input device of claim 8, wherein a top surface of the characters printing membrane is provided with a touch area and a plurality of virtual keys each printed with a character, number, or function number.
